(19) United States
(12) Patent Application Publication
(10) Pub. No.: US 2018/0114684 A1
(43) Pub. Date: Apr. 26, 2018

(54) Ion Current On-Off Switching Method and Device

(71) Applicant: DH Technologies Development PTE Ltd., Singapore (SG)

(72) Inventor: Mircea Guna, North York (CA)

(21) Appl. No.: 15/571,301

(22) PCT Filed: Mar. 29, 2016
(86) PCT No.: PCT/IB2016/051771

§ 371 Date: Nov. 2, 2017

Related U.S. Application Data
(60) Provisional application No. 62/157,273, filed on May 5, 2015.

(51) Int. Cl. H01J 49/06; H01J 49/00; H01J 49/10; H01J 49/26

(52) U.S. Cl. CPC H01J 49/061; H01J 49/0027; H01J 49/24; H01J 49/26; H01J 49/10

(57) ABSTRACT

In one aspect, a mass spectrometer is disclosed, which comprises an ion source for generating ions, a chamber comprising a curtain plate providing an inlet orifice for receiving at least a portion of said generated ions, and a deflection electrode disposed upstream of said inlet orifice and positioned relative thereto so as to modulate, in response to application of different voltages thereto, a flux of said ions reaching the inlet orifice.

### RELATED APPLICATION

This application claims priority to U.S. provisional application No. 62/157,273 filed on May 5, 2015, entitled “Ion Current On-Off Switching Method Device,” which is incorporated herein by reference in its entirety.

### FIELD

The present teachings are directed to mass spectrometry, and more particularly to methods and systems utilizing a deflection electrode to modulate the flux of ions passing through an inlet orifice of a mass spectrometer.

### INTRODUCTION

Mass spectrometry (MS) is an analytical technique for determining the elemental composition of test substances with both quantitative and qualitative applications. For example, MS can be used to identify unknown compounds, to determine the isotopic composition of elements in a molecule, and to determine the structure of a particular compound by observing its fragmentation, as well as to quantify the amount of a particular compound in the sample.

In mass spectrometry, sample molecules are generally converted into ions using an ion source and then separated and detected by one or more mass analyzers. For most atmospheric pressure ion sources, ions pass through an inlet orifice prior to entering an ion guide disposed in a vacuum chamber.

The combination of liquid chromatography and mass spectrometry (LC/MS) is an important analytical tool for identification and quantification of compounds within a mixture. Generally, in liquid chromatography, a fluid sample under analysis is passed through a column filled with a solid adsorbent material (typically in the form of small solid particles, e.g., silica). Due to slightly different interactions of the components of the mixture with the solid adsorbent material (typically referred to as the stationary phase), the different components can have different transit (elution) times through the packed column, resulting in separation of the components. The effluents exiting the LC column can then be analyzed using, e.g., MS¹ or tandem MS/MS spectrometry.

In order to increase the sensitivity of LC-MS/MS systems, the area of the sampling orifice can be increased to enhance the ion flux entering the mass analyzer. One drawback of such increase in the area of the sampling orifice is that together with the ions of interest, other ions, including in some cases heavy clusters, ionized or not, also enter the mass analyzer. These heavy particles tend to move along the axis of the mass analyzer and tend to contaminate downstream components, such as downstream lenses and electrodes. These deposits can be detrimental to the performance of the mass spectrometer.

In conventional mass spectrometers, ions generated by an ion source enter the mass analyzer even during the time periods when no data is collected, thus accelerating the contamination of the mass analyzer.

To reduce the contamination of the analyzer, it has been suggested that the ion source be turned off during the timer intervals when no data is being acquired. Such a method, however, has a number of shortcomings. For example, one disadvantage of such a method is the difficulty in stabilizing the ion source current when the ion source is subjected to rapid on-off cycles.

Accordingly, there is a need for enhanced methods and systems for reducing contamination of components of a mass spectrometer without adversely affecting its performance.

### SUMMARY

In one aspect, a mass spectrometer is disclosed, which comprises an ion source for generating ions, a chamber comprising a curtain plate providing an inlet orifice for receiving at least a portion of said generated ions, and a deflection electrode disposed upstream of said inlet orifice and positioned relative thereto so as to modulate, in response to application of different voltages thereto, a flux of said ions reaching the inlet orifice.

In some embodiments, the deflection electrode is configured such that application of at least a first voltage thereto results in an electric field in a region between the ion source and said inlet orifice that substantially inhibits the generated ions from reaching the inlet orifice (e.g., it prevents at least about 80%, or at least 90%, or 100% of the ions from reaching inlet orifice). Further, the deflection electrode is configured such that application of at least a second voltage thereto results in an electric field in the region between the ion source and the inlet orifice that directs the ions generated by source (e.g., at least 80, 90, or 100 percent of the ions) to the inlet orifice. In some embodiments, the first voltage can be in a range of about 3500 V to about 5000 V and the second voltage can be in a range of about 0 V to about 3000 V, all by way of non-limiting example.

For at least some voltages applied to the ion source (e.g., an electrode of the ion source) and the curtain plate, the voltage applied to the deflection electrode can be toggled between two values so as to inhibit the ions generated by the ion source from reaching the inlet orifice or to allow those ions to reach the inlet orifice. In some embodiments, the deflection electrode can be needle-shaped, with its tip positioned at a minimum axial distance (e.g., a distance of the needle tip from the longitudinal axis of the mass spectrometer, which extends through the inlet orifice) in a range of about 0 cm to about 1.5 cm relative to the inlet orifice, by way of non-limiting example. The deflection electrode can have a length in a range of about 0.2 cm to about 10 cm.

The mass spectrometer can further include a DC voltage source electrically coupled to the deflection electrode for application of said different voltages thereto. A controller is in electrical communication with the DC voltage source for causing the voltage source to apply said voltages to the deflection electrode. In some embodiments, the controller can be configured to cause the voltage source to apply a voltage to the deflection electrode to deflect the ions away from the inlet orifice during time intervals in which data is not collected. Further, the controller can be configured to cause the voltage source to apply a voltage to the deflection electrode to allow the ions generated by the ion source (e.g., a substantial portion of those ions, e.g., 80%, 90% or 100%) to reach and enter the inlet orifice during data acquisition time intervals. The controller applies the aforementioned voltages to the deflection electrode while the ion source is active (i.e., the ion source generates ions).

A variety of ion sources can be employed. By way of example, the ion source can be any of an atmospheric pressure chemical ionization (APCI) source, an electrospray ionization (ESI) source, a continuous ion source, a glow discharge ion source, a chemical ionization source, and a photo-ionization ion source.

In a related aspect, a mass spectrometer is disclosed, which comprises an ion source for generating ions, a chamber comprising an inlet orifice adapted to receive at least a portion of said ions for passage into said chamber, an electrode disposed upstream of said inlet orifice so as to deflect at least a portion of said ions from said inlet orifice upon application of at least one voltage thereto and to allow said ions to reach the inlet orifice upon application of at least one different voltage thereto. A DC voltage source is electrically coupled to the deflection electrode for application of said voltages thereto. The mass spectrometer further includes a controller in electrical communication with the DC voltage source for causing the voltage source to apply said voltages to said deflection electrode.

In another aspect, a method for modulating an ion flux entering an orifice inlet of a mass spectrometer is disclosed, which comprises disposing a deflection electrode between an ion source and an inlet orifice of a curtain plate of a mass spectrometer, where the ion source is adapted to generate a plurality of ions. A first voltage is applied to said deflection electrode during a first time interval so as to inhibit substantially said ions to reach said inlet orifice, and a second voltage is applied to said deflection electrode during a second time interval so as to allow said ions to reach said inlet orifice for entering said mass spectrometer. The method further comprises applying voltages to said curtain plate and said ion source so that electric field generated cooperatively by the deflection electrode, the curtain plate and the ion source substantially inhibits said ions (e.g., inhibits at least 80 percent, at least 90% or 100% of the ions) from reaching said inlet orifice in said first time interval and allows said ions (or at least 80% or more of the ions) to reach the inlet orifice during said second time interval.

In some embodiments, by way of example, the first voltage can be selected to be in a range of about 3500 V to about 5000 V, and the second voltage can be selected to be in a range of about 0 V to about 3000 V.

Further understanding of various aspects of the present teachings can be obtained by reference to the following detailed description and the associated drawings, which are discussed briefly below.

### BRIEF DESCRIPTION OF DRAWINGS

The foregoing and other objects and advantages of the invention will be appreciated more fully from the following further description, with reference to the accompanying drawings. The skilled person in the art will understand that the drawings, described below, are for illustration purposes only. The drawings are not intended to limit the scope of the applicant's teachings in any way.

FIG. 1A schematically depicts a mass spectrometer system that includes a deflection electrode in accordance with some aspects of various embodiments of the applicant's teachings.

FIG. 1B schematically depicts in perspective view the front-end of the mass spectrometer system shown in FIG. 1A.

FIGS. 2A and 2B schematically depict a portion of another exemplary mass spectrometer system that includes a deflection electrode that can be operated in various modes in accordance with some aspects of various embodiments of the applicant's teachings.

FIGS. 3A-C depict calculated equipotential lines in a conventional ion chamber and those generated by another exemplary deflection electrode being operated in two distinct modes in accordance with some aspects of various embodiments of the applicant's teachings.

FIGS. 4A-C depict calculated electric field vectors of FIGS. 3A-C.

FIGS. 5A, 5B, 5C, and 5D depict total ion current detected by an exemplary mass spectrometer system during continuous elution of a sample and MS data at specific elution times while operating the mass spectrometer system in two distinct modes in accordance with some aspects of various embodiments of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

The term “about” and “substantially identical” as used herein, refers to variations in a numerical quantity that can occur, for example, through measuring or handling procedures in the real world; through inadvertent error in these procedures; through differences/faults in the manufacture of electrical elements; through electrical losses; as well as variations that would be recognized by one skilled in the art as being equivalent so long as such variations do not encompass known values practiced by the prior art. Typically, the term “about” means greater or lesser than the value or range of values stated by 1/10 of the stated value, e.g., ±10%. For instance, applying a voltage of about +3V DC to an element can mean a voltage between +2.7V DC and +3.3V DC. Likewise, wherein values are said to be “substantially identical,” the values may differ by up to 5%. Whether or not modified by the term “about” or “substantially” identical, quantitative values recited in the claims include equivalents to the recited values, e.g., variations in the numerical quantity of such values that can occur, but would be recognized to be equivalents by a person skilled in the art.

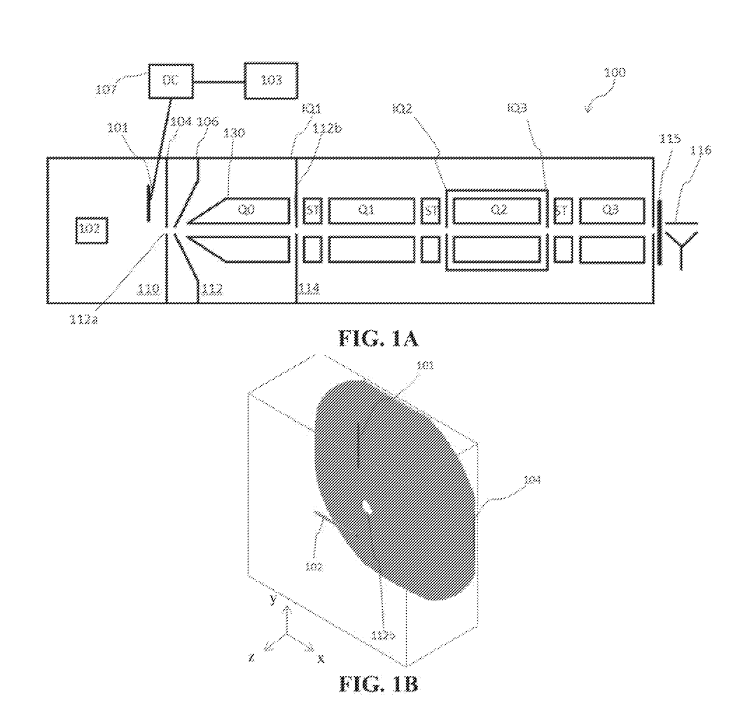

While the systems, devices, and methods described herein can be used in conjunction with many different mass spectrometer systems, an exemplary mass spectrometer system 100 for such use is illustrated schematically in FIG. 1A. It should be understood that the mass spectrometer system 100 represents only one possible mass spectrometer instrument for use in accordance with embodiments of the systems, devices, and methods described herein, and mass spectrometers having other configurations can all be used in accordance with the systems, devices and methods described herein as well.

As shown schematically in the exemplary embodiment depicted in FIG. 1A, the mass spectrometer system 100 generally comprises a QTRAP® Q-q-Q hybrid linear ion trap mass spectrometer, as generally described in an article entitled “Product ion scanning using a Q-q-Qₗᵢₙₑₐᵣ ion trap (Q TRAP®) mass spectrometer,” authored by James W. Hager and J. C. Yves Le Blanc and published in Rapid Communications in Mass Spectrometry (2003; 17: 1056-1064), which is hereby incorporated by reference in its entirety, and modified in accordance with various aspects of the present teachings. Other non-limiting, exemplary mass spectrometer systems that can be modified in accordance with the systems, devices, and methods disclosed herein can be found, for example, in U.S. Pat. No. 7,923,681, entitled “Collision Cell for Mass Spectrometer,” which is hereby incorporated by reference in its entirety. Other configurations, including but not limited to those described herein and others known to those skilled in the art, can also be utilized in conjunction with the systems, devices, and methods disclosed herein.

The exemplary mass spectrometer system 100 can comprise an ion source 102, a deflection electrode 101, an ion guide 130 (i.e., Q₀) housed within a first vacuum chamber 112, one or more mass analyzers housed within a second vacuum chamber 114, and a detector 116. It will be appreciated that though the exemplary second vacuum chamber 114 houses three mass analyzers (i.e., elongated rod sets Q1, Q2, and Q3 separated by orifice plates IQ2 between Q1 and Q2, and IQ3 between Q2 and Q3), more or fewer mass analyzer elements can be included in systems in accordance with the present teachings. For convenience, the elongated rod sets Q1, Q2, and Q3 are generally referred to herein as quadrupoles (that is, they have four rods), though the elongated rod sets can be any other suitable multipole configurations, for example, hexapoles, octapoles, etc. It will also be appreciated that the one or more mass analyzers can be any of triple quadrupoles, linear ion traps, quadrupole time of flights, Orbitrap or other Fourier transform mass spectrometers, all by way of non-limiting example.

The ion source 102 can be any known or hereafter developed ion source for generating ions and modified in accordance with the present teachings. Non-limiting examples of ion sources suitable for use with the present teachings include atmospheric pressure chemical ionization (APCI) sources, electrospray ionization (ESI) sources, continuous ion source, a glow discharge ion source, a chemical ionization source, or a photo-ionization ion source, among others.

Ions generated by the ion source 102 can be extracted into a coherent ion beam (e.g., in the z-direction along the central longitudinal axis) by passing successively through apertures in an orifice plate 104 (also referred to herein as a curtain plate) and a skimmer 106 to result in a narrow and highly focused ion beam. In various embodiments, an intermediate pressure chamber 111 can be located between the orifice plate 104 and the skimmer 106 that can be evacuated to a pressure approximately in the range of about 1 Torr to about 4 Torr, though other pressures can be used for this or for other purposes. In some embodiments, the ions can traverse one or more additional vacuum chambers and/or quadrupoles (e.g., a QJet® quadrupole or other RF ion guide) to provide additional focusing of and finer control over the ion beam using a combination of gas dynamics and radio frequency fields.

As noted above, the system 100 also includes an exemplary electrode 101 (herein also referred to as a deflection electrode) in accordance with various aspects of the present teachings. The electrode 101 is disposed within the ion chamber 110 and is upstream of the inlet orifice 112a of the curtain plate 104 and in proximity thereto. FIG. 1B also schematically depicts the relative position of the deflection electrode 101 with respect to an electrode 102 of the ion source and the inlet orifice of the curtain plate 104. Though the exemplary electrode 101 is depicted as being a conductive needle (e.g., having a length in a range of about 0.2 cm to about 10 cm), it will be appreciated that the deflection electrodes in accordance with the present teachings can have a variety of shapes and configurations to generate the exemplary electric fields for deflecting ions from the inlet orifice 112a. Likewise, it will be appreciated that the voltages applied to the deflection electrode 101, the orifice plate 104, or the ion source 102 may be modified, for example, based on the shape, size, and/or positioning of the deflection electrode relative to the ion source and/or inlet orifice.

Referring again to FIG. 1A, a DC power supply 107 under the control of a controller 103 applies DC voltages to the electrode 101 so as to modulate the ion current that passes through the inlet orifice 112a in accordance with various aspects of the present teachings. By way of non-limiting example, the controller 103 can cause the DC voltage source 107 to apply appropriate voltages to the deflection electrode 101 to alternatively allow or inhibit the passage of ions through the inlet orifice 112a. That is, the controller 103 can be programmed in a manner known in the art to cause the voltage source 107 to apply a voltage to the deflection electrode 101 to allow passage of ions through the inlet orifice 112a during temporal periods when data is to be acquired by the mass spectrometer (e.g., during elution times in which an analyte of interest is known to be eluting), and to apply another voltage to the deflection electrode 101 to inhibit the passage of ions through the inlet orifice 112a during temporal periods when data is not to be collected (e.g., during an elution time from an LC column in which no analyte of interest is eluting). In this manner, the entry of ions into the downstream mass analyzers and vacuum chambers 112, 114 during time periods when data is not acquired would be inhibited, thereby reducing contamination of the downstream mass analyzers without a need to turn the ion source 102 off and on.

More specifically, in some exemplary embodiments, the deflection electrode 101 can be switched between two modes of operation: 1) a “Current Off” mode in which the application of a first DC voltage to the deflection electrode 101 prevents or inhibits the ions generated by the source from entering the mass analyzer via the inlet orifice 112a by deflecting the ions (or at least a substantial portion of those ions, e.g., 80%, 90% or more of those ions) away from the inlet orifice 112a; and 2) a “Current On” mode in which the application of a DC voltage to the electrode 101 (or electrically grounding the electrode 101) will not result in generation of an electric field that would substantially interfere with the entry of the ions generated by the ion source 102 into the inlet orifice 112a. In other words, in the Current On mode, the ions generated by the ion source 102 can reach the inlet orifice 112a without interference from the deflection electrode 101. Thus, depending on the voltage applied to the electrode 101, the resultant electric field (which can be considered a superposition of the electric fields generated due to voltages applied to the ion source 102, the deflection electrode 101, and the curtain plate 104), the electrode 101 can be effective to modulate the ion current that passes through the inlet orifice 112a. In some embodiments, the mass spectrometer 100 can be a liquid chromatography-mass spectrometry system (e.g., LC-MS or LC-MS/MS). By way of example, in such a system the effluent from a liquid chromatography (LC) column can be delivered to the ion source 102, where one or more analytes in the effluent are ionized and directed to the mass analyzer. The presence of the deflection electrode 101 according to the present teachings can thereby be effective to modulate transmission into the mass analyzer only during specific retention windows associated with the passage of the sample through the LC column.

With continued reference to FIG. 1A, the ions received from the ion source 102 that pass through the inlet orifice 112a (e.g., in “Current On” mode) enter the vacuum chamber 112 in which a quadrupole rod set 130 (Q₀) is disposed, which guides the ions to the exit aperture 112b to the downstream mass analyzers for further processing. The vacuum chamber 112 can be associated with a mechanical pump (not shown) operable to evacuate the chamber to a pressure suitable to provide collisional cooling. For example, the vacuum chamber can be evacuated to a pressure approximately in the range of about 1 mTorr to about 10 mTorr, though other pressures can be used for this or for other purposes. For example, in some aspects, the vacuum chamber 112 can be maintained at a pressure such that pressure×length of the quadrupole rods is greater than 2.25×10⁻² Torr-cm. A lens IQ1 (e.g., an orifice plate) can be disposed between the vacuum chamber of Q0 and the adjacent chamber to isolate the two chambers 112, 114.

After being transmitted from Q0 through the exit aperture 112b of the lens IQ1, the ions can enter the adjacent quadrupole rod set Q1, which can be situated in a vacuum chamber 114 that can be evacuated to a pressure that can be maintained lower than that of ion guide chamber 112. By way of non-limiting example, the vacuum chamber 114 can be maintained at a pressure less than about 1×10⁻⁴ Torr (e.g., about 5×10⁻⁵ Torr), though other pressures can be used for this or for other purposes. As will be appreciated by a person of skill in the art, the quadrupole rod set Q1 can be operated as a conventional transmission RF/DC quadrupole mass filter that can be operated to select an ion of interest and/or a range of ions of interest. By way of example, the quadrupole rod set Q1 can be provided with RF/DC voltages suitable for operation in a mass-resolving mode. As should be appreciated, taking the physical and electrical properties of Q1 into account, parameters for an applied RF and DC voltage can be selected so that Q1 establishes a transmission window of chosen m/z ratios, such that these ions can traverse Q1 largely unperturbed. Ions having m/z ratios falling outside the window, however, do not attain stable trajectories within the quadrupole and can be prevented from traversing the quadrupole rod set Q1. It should be appreciated that this mode of operation is but one possible mode of operation for Q1. By way of example, the lens IQ2 between Q1 and Q2 can be maintained at a much higher offset potential than Q1 such that the quadrupole rod set Q1 be operated as an ion trap. In some aspects, the ions can be Mass-Selective-Axially Ejected from the Q1 ion trap in a manner described by Hager in “A new Linear ion trap mass spectrometer,” Rapid Commun. Mass Spectro. 2002; 16: 512-526, and accelerated into Q2, which could also be operated as an ion trap, for example.

Ions passing through the quadrupole rod set Q1 can pass through the lens IQ2 and into the adjacent quadrupole rod set Q2, which as shown can be disposed in a pressurized compartment and can be configured to operate as a collision cell at a pressure approximately in the range of from about 1 mTorr to about 10 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. In some embodiments, the quadrupole rod set Q2 and entrance and exit lenses IQ2 and IQ3 can also be configured as an ion trap.

Ions that are transmitted by Q2 can pass into the adjacent quadrupole rod set Q3, which is bounded upstream by IQ3 and downstream by the exit lens 115. As will be appreciated by a person skilled in the art, the quadrupole rod set Q3 can be operated at a decreased operating pressure relative to that of Q2, for example, less than about 1×10⁻⁴ Torr (e.g., about 5×10⁻⁵ Torr), though other pressures can be used for this or for other purposes. As will be appreciated by a person skilled in the art, Q3 can be operated in a number of manners, for example as a scanning RF/DC quadrupole or as a linear ion trap. Following processing or transmission through Q3, the ions can be transmitted into the detector 116 through the exit lens 115. The detector 116 can then be operated in a manner known to those skilled in the art in view of the systems, devices, and methods described herein. As will be appreciated by a person skill in the art, any known detector, modified in accord with the teachings herein, can be used to detect the ions.

It should also be understood that the teachings of invention are not limited to the exemplary mass spectrometer discussed above, and can be implemented in a variety of different mass spectrometers to reduce, and preferably eliminate, the contamination of the mass analyzers during time intervals when data is not acquired.

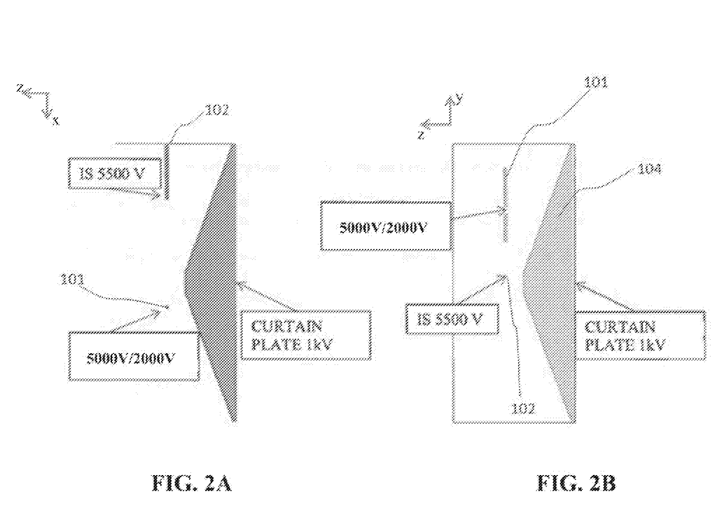

It will be appreciated in light of the teachings herein that the ion source 102, the deflection electrode 101, and the orifice plate 104 can have a variety of voltages applied thereto in accordance with various aspects of the present teachings to control the electric fields experienced by the ions in the region between the ion source and the inlet orifice 112a. With reference to FIGS. 2A and 2B, in one exemplary implementation, the ion source 102 can operate at a voltage of about 5500 volts (V) and the curtain plate 104 can be maintained at a DC voltage of about 1 kV. In this exemplary implementation, the application of a voltage of about 3500V to the deflection electrode 101 will result in Current On mode (i.e., the generated ions reach the inlet orifice 112a), while the application of about 5000 V to the deflection electrode 101 will result in Current Off mode (i.e., the ions will be deflected away from the inlet orifice 112a). It should be understood that the above-recited voltages are exemplary, and that other voltages can be applied to the deflection electrode 101 to switch between the Current On mode and the Current Off mode in accordance with various aspects of the present teachings. By way of example, in some embodiments, the DC voltage applied to the deflection electrode 101 in the Current Off mode can be in a range of about 3500 V to about 5000 V and the DC voltage applied to the deflection electrode 101 in the Current On mode can be in a range of about 0 V to about 3000 V, though a person skilled in the art will appreciate that other suitable voltages are suitable for use in accordance with the present teachings (e.g., depending on the system configuration such as relative spacing of ion source, deflection electrode, and inlet orifice, and the potentials applied thereto).

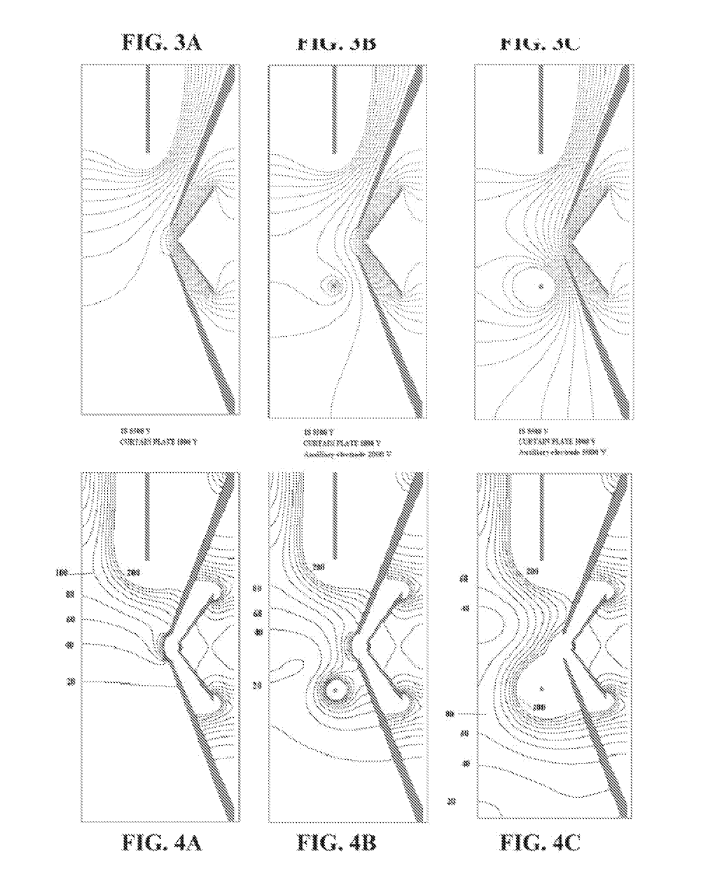

By way of further illustration, FIGS. 3A-C and 4A-C depict calculated equipotential lines and the electric field vectors (in V/mm) in a conventional ion chamber (i.e., without a deflection electrode) and those generated in an exemplary ion chamber according to various aspects of the present teachings having an exemplary deflected electrode to which various voltages can be applied. First, with specific reference to FIG. 3A and FIG. 4A, the lines in FIG. 3A represent equipotential lines when the ion source is maintained at 5500 V and the curtain plate at 1000V, while the lines in FIG. 4A represent the electric field generated within an exemplary, conventional ion chamber (i.e., without a deflection electrode). The electric field vectors (in V/mm) are perpendicular to the depicted equipotential lines. In this conventional configuration, most of the ions generated by the ion source would be drawn toward and enter the inlet orifice of the curtain plate.

With reference now to FIGS. 3B and 4B, a deflection electrode in accordance with various aspects of the present teachings is disposed in proximity to the inlet orifice. Simulated equipotential lines in FIG. 3B and the resulting electric field vectors in FIG. 4B are depicted when the ion source is maintained at 5500 V and the curtain plate at 1000V (as above), while the deflection electrode also has a voltage of 2000 V applied thereto. In observing the similarities in the electric field of FIG. 4B with that of FIG. 4A in the regions between the ion source and the inlet orifice, it will be appreciated that the electric field is substantially unchanged by the addition of the deflection electrode. This exemplary configuration of the deflection electrode represents the “Current On” mode discussed above as most of the ions would again be able to enter the inlet orifice of the curtain plate.

With reference now to FIGS. 3C and 4C, the simulated equipotential lines in FIG. 3C and the resulting electric field vectors in FIG. 4C are depicted upon switching the deflection electrode into “Current Off” mode by increasing the voltage applied to the deflection electrode to 5000 V, by way of non-limiting example. In observing the differences now in the electric field between FIG. 4C and FIG. 4B in the regions between the ion source and the inlet orifice, it will be appreciated that the electric field has changed substantially in FIG. 4C and would be effective to deflect away from the inlet orifice ions generated by the ion source. This exemplary configuration of the deflection electrode in FIGS. 3C and 4C therefore represents the “Current Off” mode discussed above. Experimentally, it was determined that in response to application of a voltage of 5500 V to the ion source needle and of 5000 V to the deflection electrode, the ion signal dropped to 0.4% of its normal value (i.e., the signal obtained without the deflection electrode). Upon application of voltage of 2000 V to the deflection electrode, the acquired signal level was the same as that obtained in absence of the deflection electrode.

The following examples are provided for further elucidation of various aspects of the present teachings. The examples are only for illustrative purposes and are not intended to indicate necessarily the optimal ways of practicing the present teachings or the optimal results that may be obtained.

### EXAMPLE 1

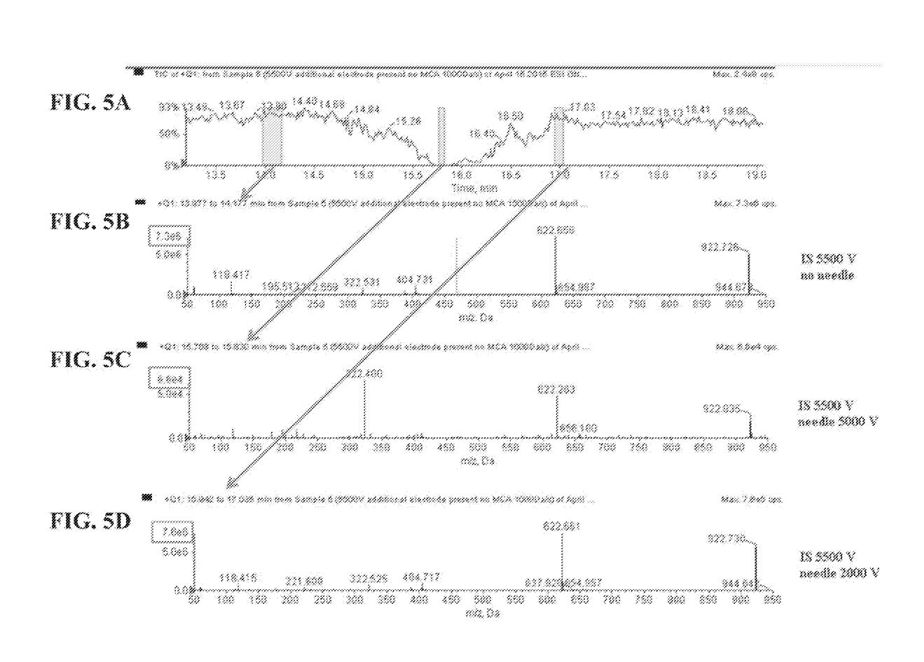

With reference now to FIGS. 5A-D, exemplary MS data is depicted as generated by a QTRAP® 5500 System (marketed by SCIEX and similar to the exemplary system schematically depicted in FIG. 1 with a QJet® upstream of Q0) that receives ions generated by an electrospray ion source, and modified to include a deflection electrode upstream of the inlet orifice of the curtain plate in accordance with various aspects of the present teachings. The data were acquired with Q1 operating in RF/DC mode and with Q2 and Q3 in RF-only mode. No collision gas was added to Q2 collision cell. The RF/DC voltages were scanned from m/z 50 to m/z 950 at a scan rate of 200 Da/s. The distance between the deflection electrode and the center of the curtain plate orifice was 0.5 cm, while the distance between the ion source and the curtain plate orifice was approximately 1 cm. The curtain plate orifice was 3 mm in diameter and the orifice in the skimmer plate was 0.62 cm.

With reference first to FIG. 5A, total ion current detected by the mass spectrometer system is depicted during continuous elution of Agilent Mix (1:100 95/5 acetonitrile/water dilution of the electrospray Calibrant Solution G2421A obtained from Agilent Technologies of Canada Mississauga, ON).

FIGS. 5B-D depict the specific MS data at three specific elution times used to generate the XIC of FIG. 5A. Specifically, FIGS. 5B-5D were obtained by utilizing the various configurations schematically depicted in FIGS. 3A-C and 4A-C at the specific elution times. The MS spectra of FIG. 5B was obtained at an elution time of about 14 minutes and utilized the conventional configuration depicted in FIG. 3A (i.e., no deflection electrode, ion source maintained at 5500 V, curtain plate maintained at 1000V). The MS spectra of FIG. 5C was obtained at an elution time of about 15.8 minutes and utilized the “Current Off” configuration depicted in FIG. 3C (i.e., deflection electrode set at 5000V, ion source maintained at 5500 V, curtain plate maintained at 1000V). The MS spectra of FIG. 5D was obtained at an elution time of about 17 minutes and utilized the “Current On” configuration depicted in FIG. 3B (i.e., deflection electrode set at 5000V, ion source maintained at 5500 V, curtain plate maintained at 1000V).

As demonstrated in the middle portion of FIG. 5A, when the system was modified from a conventional system to include a deflection electrode operated in Current Off mode (i.e., deflection electrode at 5000V), the detected ion intensity decreased (e.g., from about 15.5 minutes to about 16.5 minutes). Specifically, as shown in FIGS. 5B and 5C, the ion intensity dropped more than 100-fold relative to the conventional operation when operating the system in “Current Off” mode (max intensity of 7.3e6 in FIG. 5B vs. max intensity of 6.6e4 in FIG. 5C). As seen in the right portion of FIG. 5A, however, when the voltage on the deflection electrode was decreased to 2000V (i.e., in the Current On mode), the detected ion intensity again increased to substantially the same level as in the conventional mode (max intensity of 7.3e6 in FIG. 5B vs. max intensity of 7.6e4 in FIG. 5D).

Those skilled in the art will know or be able to ascertain using no more than routine experimentation, many equivalents to the embodiments and practices described herein. By way of example, the dimensions of the various components and explicit values for particular electrical signals (e.g., amplitude, frequencies, etc.) applied to the various components are merely exemplary and are not intended to limit the scope of the present teachings. Accordingly, it will be understood that the invention is not to be limited to the embodiments disclosed herein, but is to be understood from the following claims, which are to be interpreted as broadly as allowed under the law.

The section headings used herein are for organizational purposes only and are not to be construed as limiting. While the applicant's teachings are described in conjunction with various embodiments, it is not intended that the applicant's teachings be limited to such embodiments. To the contrary, the applicant's teachings encompass various alternatives, modifications, and equivalents, as will be appreciated by those of skill in the art. Those having ordinary skill in the art will appreciate that various changes can be made to the above embodiments without departing from the scope of the invention.

What is claimed is:

1. A mass spectrometer, comprising:
an ion source for generating ions,
a chamber comprising a curtain plate providing an inlet orifice for receiving at least a portion of said generated ions,
a deflection electrode disposed upstream of said inlet orifice and positioned relative thereto so as to modulate, in response to application of different voltages thereto, a flux of said ions reaching the inlet orifice.

2. The mass spectrometer of claim 1, wherein said electrode is configured such that application of at least a first voltage thereto results in an electric field in a region between the ion source and said inlet orifice that substantially inhibits the generated ions from reaching the inlet orifice.

3. The mass spectrometer of claim 2, wherein said electrode is configured such that application of at least a second voltage thereto results in an electric field in said region between the ion source and said inlet orifice that substantially directs the generated ions to said inlet orifice.

4. The mass spectrometer of claim 3, further comprising a DC voltage source electrically coupled to said deflection electrode for application of said different voltages thereto.

5. The mass spectrometer of claim 3, further comprising a controller in electrical communication with said DC voltage source for causing the voltage source to apply said voltages to said deflection electrode.

6. The mass spectrometer of claim 5, wherein said controller is configured to cause the voltage source to apply said at least first voltage to said deflection electrode during data acquisition time periods.

7. The mass spectrometer of claim 6, wherein said controller is configured to cause the voltage source to apply said at least second voltage to said deflection electrode during time periods when no data acquisition is taking place.

8. The mass spectrometer of claim 5, wherein said controller causes the voltage source to apply said different voltages to said deflection electrode while the ion source is active.

9. The mass spectrometer of claim 2, wherein said at least first voltage is in a range of about 3500 V to about 5000 V.

10. The mass spectrometer of claim 3, wherein said at least second voltage is in a range of about 0 V to about 3000 V.

11. The mass spectrometer of claim 1, wherein said deflection electrode is needle shaped.

12. The mass spectrometer of claim 1, wherein an axial distance of the deflection electrode from said inlet orifice is in a range of about 0 cm to about 1.5 cm.

13. The mass spectrometer of claim 1, wherein said ion source is any of an atmospheric pressure chemical ionization (APCI) source, an electrospray ionization (ESI) source, a continuous ion source, a glow discharge ion source, an, a chemical ionization source, and a photo-ionization ion source,

14. A mass spectrometer, comprising:
an ion source for generating ions,
a chamber comprising an inlet orifice adapted to receive at least a portion of said ions for passage into said chamber,
an electrode disposed upstream of said inlet orifice so as to deflect at least a portion of said ions from said inlet orifice upon application of at least one voltage and to allow said ions to reach the inlet orifice upon application of at least one different voltage thereto.

15. The mass spectrometer of claim 14, further comprising a DC voltage electrically coupled to said deflection electrode for application of said voltages thereto.

16. The mass spectrometer of claim 15, further comprising a controller in electrical communication with said DC voltage source for causing the voltage source to apply said voltages to said deflection electrode.

17. A method for modulating an ion flux entering an orifice inlet of a mass spectrometer, comprising:
disposing a deflection electrode between an ion source an inlet orifice of a curtain plate mass spectrometer, said ion source being adapted to generate a plurality of ions,
applying a first voltage to said deflection electrode during a first time interval so as to inhibit substantially said ions to reach said inlet orifice,
applying a second voltage to said deflection electrode during a second time interval so as to allow said ions to reach said inlet orifice for entering said mass spectrometer.

18. The method of claim 17, further comprising applying voltages to said curtain plate and said ion source so that electric field generated cooperatively by said first voltage applied to the deflection electrode and said voltages applied to the curtain plate and the ion source substantially inhibits said ions from reaching said inlet orifice in said first time interval and allows said ions to reach the inlet orifice during said second time interval.

19. The method of claim 17, wherein said first voltage is selected to be in a range of about 3500 V to about 5000 V.

20. The method of claim 17, wherein said second voltage is selected to be in a range of about 0 V to about 3000 V.
